(19) United States
(12) Patent Application Publication
(10) Pub. No.: US 2011/0158755 A1
(43) Pub. Date: Jun. 30, 2011

(54) Planar Cutting Tool and Associated Tool Holder

(75) Inventor: Andre Churlet, Moirans en Montagne (FR)

(73) Assignee: SARL FAC, Moirans en Montagne (FR)

(21) Appl. No.: 13/061,275

(22) PCT Filed: Sep. 9, 2009
(86) PCT No.: PCT/FR09/51697

§ 371 Date: Feb. 28, 2011

(30) Foreign Application Priority Data
Sep. 16, 2008 (FR) 08/56225

(51) Int. Cl. B23B 27/00; B23B 31/20

(52) U.S. Cl. 407/11; 407/107

(57) ABSTRACT

The invention relates to a rotary or fixed cutting tool for machining elements made of a hard and/or abrasive material, said tool comprising at least one active portion having hardness and/or abrasion properties higher than that of the material to be machined, and a passive portion interacting with a tool holder including a clamp, characterised in that the active portion and the passive portion of said tool are formed by an intergral plate defining both portions and obtained directly from a blank having a predetermined constant thickness and a hardness corresponding to that of the active portion so as to obtain a planar tool, and in that the passive portion is elongate and has a constant substantially quadrangular cross-section for interaction with a housing with a corresponding cross-section in the clamp, wherein the integral planar tool thus formed is directly mounted in the housing secured by tightening the same in the clamp.

This invention relates to a cutting tool, rotary or fixed, intended for machining elements made of a hard and/or abrasive material, which tool consists of at least one active portion having hardness and/or abrasion properties superior to those of the material to be machined, and a passive portion intended to cooperate with a tool holder comprising a clamp.

It is currently known to produce tools enabling this type of machining, consisting of a cylindrical body made of carbide or steel, or another material, provided at the end with spaces in which highly abrasive plates are attached.

These plates are attached by means of brazing, by a screw passing through it and screwed into the tool body, or by holding pins, etc.

Once attached, the plate will be sharpened as needed for cutting.

Such operations for obtaining a highly abrasive cutting tool result in a high cost.

This type of well known tool is intended to be placed between the jaws of a clamp or a mandrel, defining, at the center, a bore over the entire height. The tool is then immobilized by means of a coupling nut or lateral screws, for example.

Such an embodiment is complex, costly and has the disadvantage of being imprecisely manufactured.

Indeed, the spaces produced on the tool body are sources of defects, for example when the abrasive plates are brazed, because the thickness of the brazing is not controlled. There is therefore a problem of positioning the cutting material, which is not in the axis of the tool, thereby creating a low-quality tool. Moreover, small tools are difficult to produce because there is no place to put one or more screws or one or more flanges, and, in the case of brazing, it will not be precise enough.

The objective of the present invention is therefore to create a high-precision rotary or fixed cutting tool that will be intended for machining, surface milling, drilling, etching and so on, using already existing materials precisely intended for producing the aforementioned attached plates, and which are produced by polycrystalline diamond agglomerates (PCD) or polycrystalline cubic boron nitride (PCBN), or tungsten carbide (WC).

To this end, the invention relates to a rotary or fixed cutting tool intended for machining elements made of a hard and/or abrasive material, consisting of at least one active portion having hardness and/or abrasion properties superior to those of the material to be machined, and a passive portion intended to cooperate with a tool holder comprising a clamp, characterized in that the active portion and the passive portion of said tool are formed by a one-piece plate defining the two portions, obtained directly from a blank with a predetermined constant thickness and a hardness corresponding to that of the active portion, so as to obtain a planar tool, and in that the passive portion is elongate with a constant cross-section, generally quadrangular, intended to cooperate with a housing with a corresponding cross-section of the clamp, in which housing the planar one-piece tool thus formed is mounted directly for attachment by clamping in the clamp.

Thus, owing to the precision of the housing with a cross-section corresponding to that of the tool plate, capable of being rectangular, trapezoidal or square, and the positioning thereof in the clamp, it is possible to easily fit the planar tool therein, with the cutting portion positioned precisely, for example at the center or in the transverse axis, or the like.

Thus, and according to the main advantage of the invention, the intermediate cylindrical body of the tool, made of carbide or steel according to the prior art, is replaced by a one-piece non-cylindrical tool obtained directly by cutting in a blank of an agglomerate of the aforementioned type, which is therefore planar.

The invention is industrially applicable in the machining of highly abrasive materials such as aluminum, titanium, carbon in its various forms, glass filled plastic, bakelite, gold, wood (medium), and so on.

Finally, it should be mentioned that there was a real problem of moving from the current technology based on the use of a cylindrical tool also having a cylindrical shank, on which an abrasive plate is attached, to the technology according to the invention by producing a planar, one-piece tool without an attached part. This indeed overcomes a prejudice, demonstrating a real inventive step.

The invention also relates to features that will become indicated in the following description, and that should be considered alone or in all of their possible technical combinations.

This description, provided as a non-limiting example, will make it easier to understand how the invention can be produced, in reference to the appended drawings, in which:

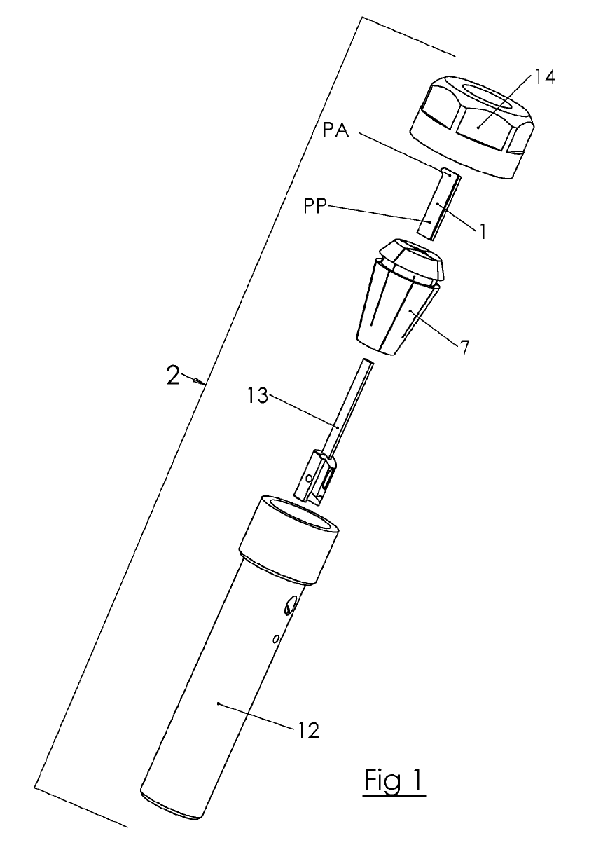

FIG. 1 shows an exploded perspective view of a tool holder and the associated tool plate thereof.

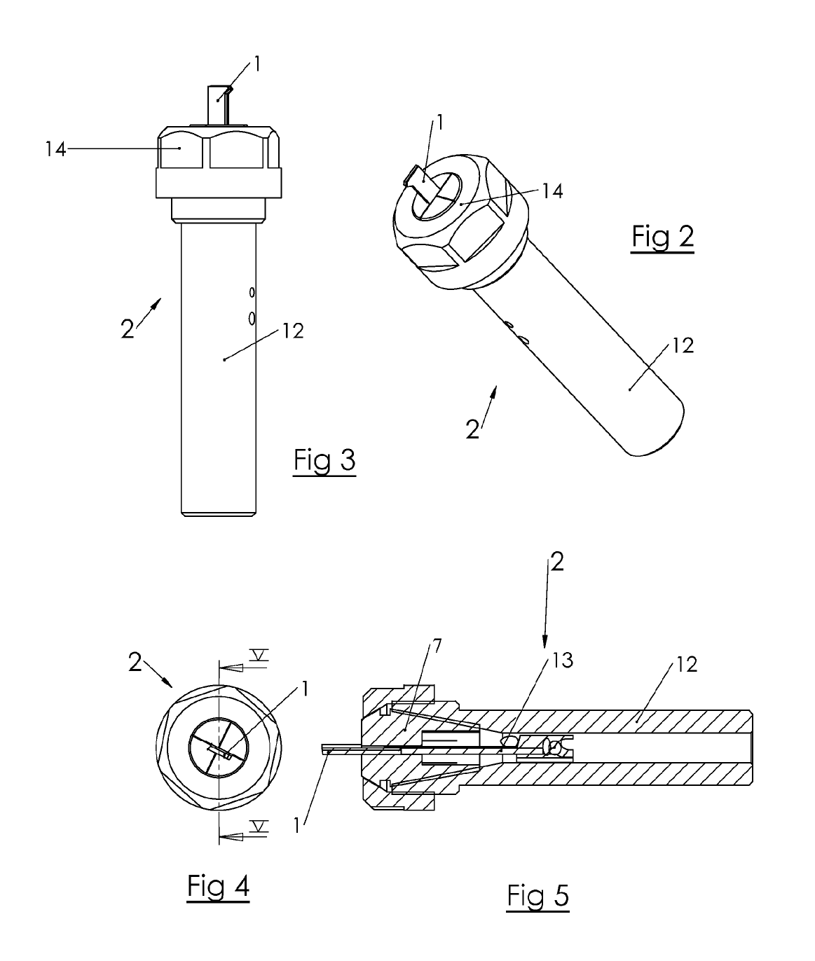

FIG. 2 shows, in perspective, the tool holder and tool plate assembly after assembly.

FIG. 3 shows a plan view according to FIG. 2.

FIG. 4 shows a top view according to FIG. 2.

FIG. 5 shows a cross-section view according to line VV in FIG. 4.

FIG. 6 shows, on an enlarged scale, a tool holder clamp, in perspective, according to the embodiment of FIGS. 1 to 5.

FIG. 7 is a top view according to FIG. 6.

FIGS. 8 and 9 are side views according to the two perpendicular axes of FIG. 7.

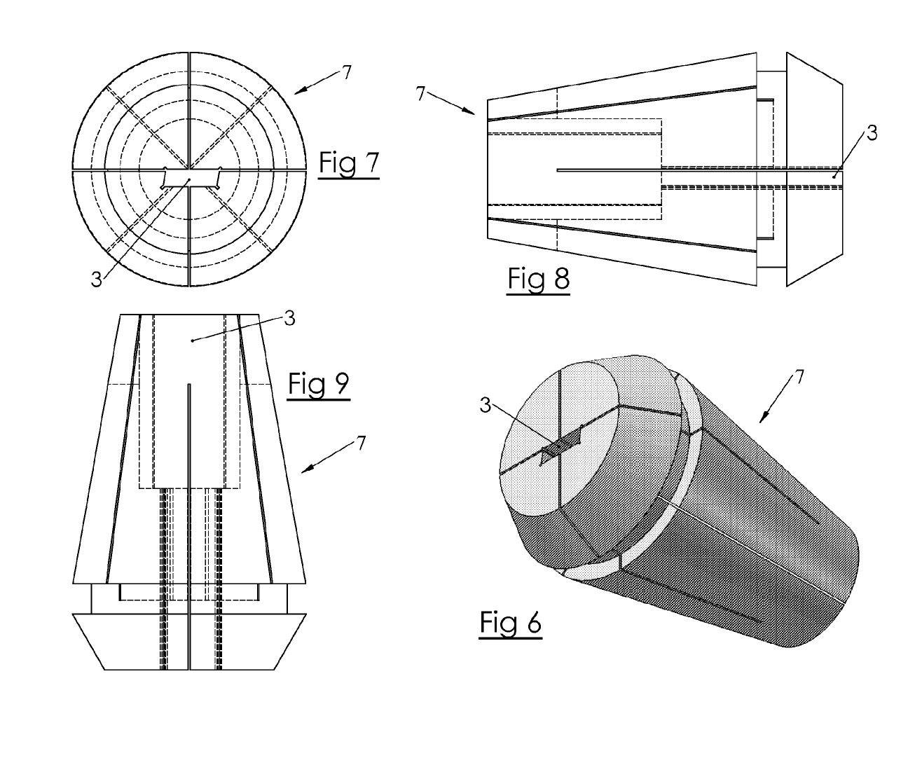

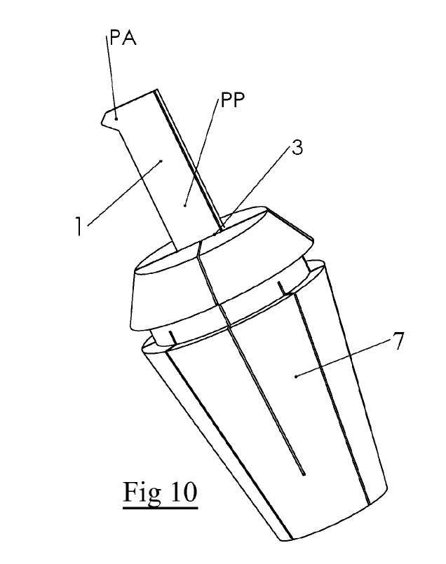

FIG. 10 is a perspective view according to FIG. 6, after assembly of a tool plate.

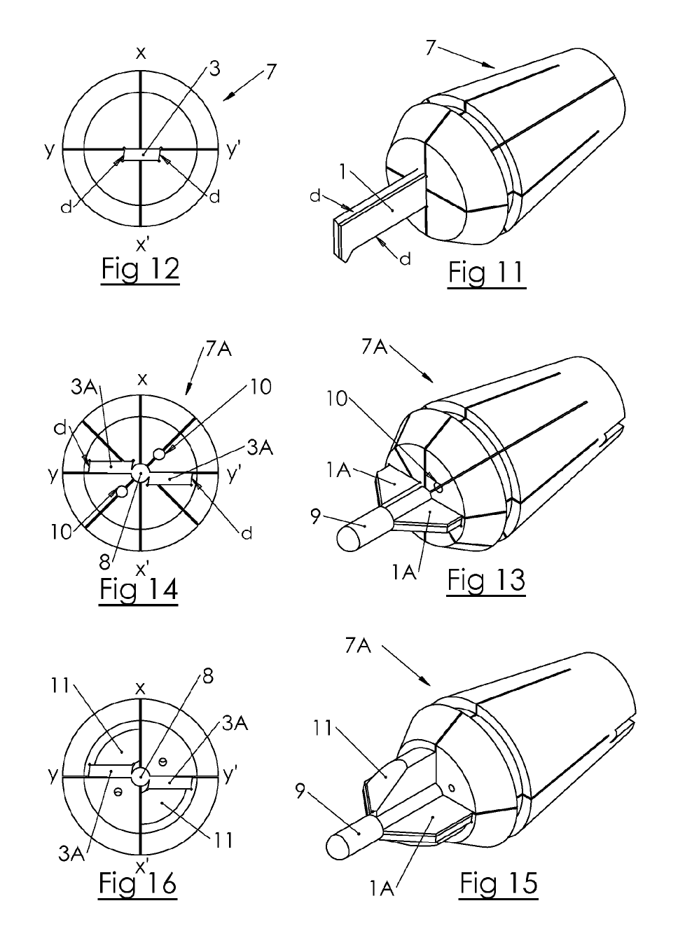

FIGS. 11 and 12 show a tool holder clamp, respectively in perspective and in a top view, according to a first embodiment.

FIGS. 13 and 14 show a tool holder clamp, respectively in perspective and in a top view, according to a second embodiment.

FIGS. 15 and 16 show a tool holder clamp, respectively in perspective and in a top view, according to a third embodiment.

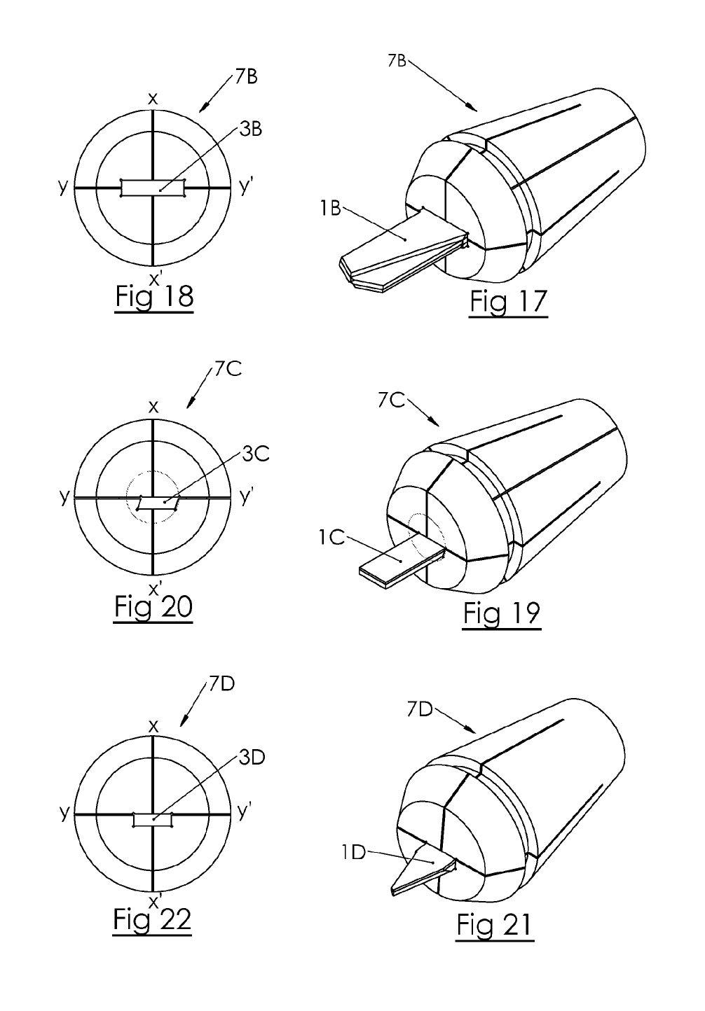

FIGS. 17 and 18 show a tool holder clamp, respectively in perspective and in a top view, according to a fourth embodiment.

FIGS. 19 and 20 show a tool holder clamp, respectively in perspective and in a top view, according to a fifth embodiment.

FIGS. 21 and 22 show a tool holder clamp, respectively in perspective and in a top view, according to a sixth embodiment.

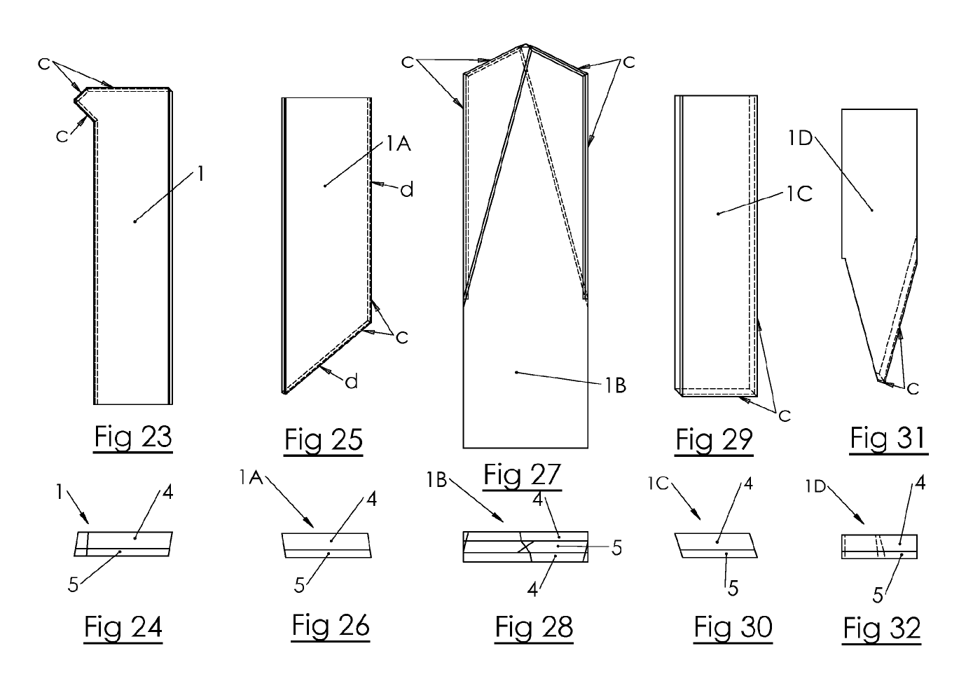

FIGS. 23 and 24 show a tool, respectively in a plane view and an end view, according to FIGS. 11 and 12.

FIGS. 25 and 26 show a tool, respectively in a plane view and an end view, according to FIGS. 13-14 and 15-16.

FIGS. 27 and 28 show a tool, respectively in a plane view and an end view, according to FIGS. 17 and 18.

FIGS. 29 and 30 show a tool, respectively in a plane view and an end view, according to FIGS. 19 and 20.

FIGS. 31 and 32 show a tool, respectively in a plane view and an end view, according to FIGS. 21 and 22.

The cutting tool 1, 1A, 1B, 1C and 1D, which can be rotary or fixed according to the uses, is intended for machining elements made of a hard and/or abrasive material, consisting of at least one active portion having hardness and/or abrasion properties superior to those of the material to be machined, and a passive portion intended to cooperate with a tool holder 2 comprising a clamp 7.

According to a first feature of the invention, the active portion “PA” and the passive portion “PP” of said tool are formed by a one-piece plate defining the two portions, obtained directly from a blank with a predetermined constant thickness and a hardness corresponding to that of the active portion “PA”, so as to obtain a planar tool.

According to a second feature of the invention, the passive portion “PP” of the same tool plate is elongate and has a constant cross-section, generally quadrangular, intended to cooperate with a housing 3, 3A, 3B, 3C, 3D with a corresponding cross-section of the clamp 7, in which housing 3, 3A, 3B, 3C, 3D the planar one-piece tool 1, 1A, 1B, 1C, 1D thus formed is mounted directly for attachment by clamping in the clamp 7.

According to a first embodiment, the material forming the blank from which it is made is a polycrystalline diamond (PCD) agglomerate consisting of diamond powder and a cobalt binder, on a carbide base, all compacted.

According to a second embodiment, the material forming the blank from which the tool is made is a cubic boron nitride (PCBN).

According to a third embodiment, the material forming the blank from which the tool is made is a one-piece tungsten carbide (WC).

According to the various embodiments shown in all of the figures, with the exception of that shown in FIGS. 17, 18 and 27, 28, the blank from which the tool is made consists of two layers 4, 5, one 4 neutral forming a support, and the other 5 abrasive, made of PCD or PCBN deposited on a face of the support, in order to form a blank with the desired thickness.

According to the embodiment of FIGS. 17, 18 and 27, 28, the blank from which the tool is made consists of three layers 4,5, 4, one 5 central, consisting of PCD or PCBN, and the other two 4 outer, located on each side of the central layer 5 forming carbide supports, in order to produce a blank with the desired thickness.

According to this last particular case, which in fact concerns a drill, the cutting portion 5 is located between the two carbide faces 4, according to a predetermined point angle, in which the housing produced in the clamp (see FIG. 18) in which it is mounted has a rectangular cross-section and is produced symmetrically according to its perpendicular axes XX′, YY′.

According to one of the features of the invention, the tool plate is obtained directly from the blank by cutting.

In reference to FIGS. 11 and 12, according to the first embodiment of the tool plate 1, it has a generally quadrangular cross-section, with drafts “d”. The corresponding housing 3, comprising the same drafts, is produced symmetrically or not with respect to one of the axes XX′ of a clamp 7 of the tool holder 2. The same housing 3 is located on a side of the other axis YY′ of the same clamp 7.

According to the second embodiment of FIGS. 13 and 14, which involves the tool plate 1A, there are two of them located on each side of a central axis of the clamp 7A.

Still according to this embodiment, the tool plates 1A are beveled at their active end and are housed, as above, in quadrangular housings comprising drafts “d”, but produced on each side of the axis XX′, and above and below the axis YY′. A central hole 8 is also provided in the clamp 7A, so as to insert a cylindrical guide element 9, a cylindrical drill, a cylindrical milling tool or a screw tap. Lubrication holes 10 are provided for supplying lubricant during machining.

The second embodiment shown in FIGS. 15 and 16 differs essentially in that reinforcement plates 11 are provided near the tool plates 1A.

According to a third embodiment, and as already mentioned above, FIGS. 17 and 18 implementing the tool holder 1B, in fact a planar drill, has a housing 3B that is perfectly centered according to axes XX′ and YY′ of the clamp 7B.

According to the fourth alternative embodiment, shown in FIGS. 19 and 20 implementing the tool plate 1C, it has a planar end and is mounted in a housing 3C of the clamp 7C, asymmetrically with respect to the axis XX′, and on one side of the axis YY′.

According to a fifth embodiment, shown in FIGS. 21 and 22 implementing a tool plate 1D in a housing 3D of the clamp 7D, said housing is centered according to the axis XX′ and located on one side of the axis YY′.

Of course, any other embodiment different from the tool plate as well as the corresponding housing, in the cross-section and in the positioning, is part of the present invention.

The cutting portion “c” of the tool plates, with regard to the drill, must of course be at the center and at the end of the drill. However, it can be at the axis for milling tools or for any other housing positioned as needed on the clamp. The tool plate thus held in the clamp will be used for machining, roll milling, surfacing, drilling, screw tapping and etching, in particular with regard to the tool 1D shown in FIGS. 21-22 and 31-32.

It should also be noted that, if the longitudinal axes of the tool plates shown in all of the embodiments mentioned above are perpendicular to the front face of the clamps 7, said axes may also be inclined, and therefore no longer perpendicular to the same face.

Also, still according to the same examples shown, if the number of tool plates is limited to two, it is certain that there may be more according to the use.

The tool holder 2 for implementing a cutting tool 1, 1A, 1B, 1C, 1D described above consists, as can be seen in FIGS. 1 to 5, of:
a cylindrical hollow body 12 containing
a longitudinal stop 13 intended for axial positioning with adjustable depth of the tool 1, 1A, 1B, 1C, 1D,
a clamp 7 comprising conical clamping jaws, for clamping by means of
a clamping ring 14 exerting an action on the jaws, and consequently on the tool 1 once in place in
a housing 3, 3A, 3B, 3C, 3D with a corresponding cross-section, positioned between the jaws of the clamp 7.

Thus, the tool plates 1 can be adjusted in order to adjust the projecting portion of the clamp 7, by means of one or more screws, which, by being screwed, will enable the stop(s) having a planar shape similar to the shape of the passive portion “PP” of the tool plate to be mounted.

Thus, the tool plates may slide into their housing, which will enable them to be adjusted by means of a special stop, at the desired height, outside of the clamp 7.

The clamps 7 will be adapted for each tool plate 1 (housing 3, slots of the clamp, stop-push member 13, rear support). The clamps 7 may also comprise a reinforcement behind the projecting portion of the tool plate; it will hold and support the tool plate during use.

With regard to the adjustment stop 13, the push portion thereof goes into the clamp 7, hence the need for a planar shape that is smaller than the space of the tool plate, with operating clearance.

It is necessary for the push portion of the stop to penetrate the clamp in order to have the smallest possible passive area and reduce the cost of the tool. The push portion of the stops may be interchangeable, i.e. it can be more or less long and more or less wide. It is held, for example, by a pin. The fine adjustment will be performed with screws that are on the cylindrical body holding the clamp 7.

In some cases, the body 12 and the clamp 7 can be made in one piece, and the adjustment screws positioned behind the tool holder.

Finally, with regard to the lubrication holes 10 produced through the clamp 7, they will be oriented so as to correspond to the most effective orientation for lubrication.

1. A cutting tool, rotary or fixed, intended for machining elements made of a hard and/or abrasive material, carbon, titanium for example, consisting of at least one active portion having hardness and/or abrasion properties superior to those of the material to be machined, and a passive portion intended to cooperate with a tool holder comprising a clamp, wherein the active portion and the passive portion of said tool are formed by a one-piece plate defining the two portions, obtained directly from a blank with a predetermined constant thickness and a hardness corresponding to that of the active portion, so as to obtain a planar tool, and in that the passive portion is elongate with a constant cross-section, generally quadrangular, intended to cooperate with a housing with a corresponding cross-section of the clamp, in which housing the planar one-piece tool thus formed is mounted directly for attachment by clamping in the clamp.

2. The tool according to claim 1, wherein the longitudinal axis is perpendicular to the front face of the clamp.

3. The tool according to claim 1, wherein the longitudinal axis is inclined with respect to the front face of the clamp.

4. The tool according to claim 1, wherein said tool further comprises a double tool, with each tool being arranged on different sides of a central axis of the clamp.

5. The tool according to claim 4, wherein each tool is beveled at the active portion and fits into quadrangular housings comprising drafts, but produced on different sides of the axis, and above and below the axis, in which a central hole is also provided in the clamp, so as to insert a cylindrical guide element, a cylindrical drill, a cylindrical milling tool or a screw tap.

6. The tool according to one of claims 4 or 5, wherein lubrication holes are provided for the supply of lubricant during machining.

7. The tool according to one of claims 4 or 5, characterized in that reinforcing plates are provided near the tools.

8. The tool according to claim 1, wherein the tool has a planar end and is mounted in a housing of the clamp, asymmetrically with respect to the axis, and on one side of the axis.

9. The tool according to claim 1, wherein the tool is mounted in a housing of the clamp, in which said housing is centered according to the axis and located on one side of the axis.

10. The tool according to claim 1, wherein the tool holder for implementing a cutting tool consists of:
a cylindrical hollow body containing
a longitudinal stop intended for axial positioning with adjustable depth of the tool,
a clamp comprising conical clamping jaws, for clamping by means of
a clamping ring exerting an action on the jaws, and consequently on the tool once in place in; and
a housing with a corresponding cross-section, positioned between the jaws of the clamp.

11. The tool according to claim 10, wherein the body and the clamp of the tool holder are made in a single piece.

12. The tool according to claim 1, wherein the tool plates can be cut from a blank of polycrystalline diamond agglomerates, or cubic boron nitride, or tungsten carbide.
